(19) United States
(12) Patent Application Publication
(10) Pub. No.: US 2017/0136662 A1
(43) Pub. Date: May 18, 2017

(54) METHOD OF MANUFACTURING FOLDED BODY OF AIRBAG

(71) Applicant: TOYODA GOSEI CO., LTD., Kiyosu-shi (JP)

(72) Inventors: Takanori KOMATSU, Kiyosu-shi (JP); Hideo HIGASHI, Kiyosu-shi (JP)

(21) Appl. No.: 15/348,522

(22) Filed: Nov. 10, 2016

(30) Foreign Application Priority Data
Nov. 13, 2015 (JP) 2015-223409

(51) Int. Cl. B29C 43/14; B29C 43/52; B60R 21/215; B60R 21/237; B60R 21/203

(52) U.S. Cl. CPC B29C 43/14; B60R 21/237; B60R 21/203; B60R 21/215; B29C 43/52; B60R 2021/21537; B60R 2021/21543; B29C 2043/141; B29L 2022/027

(57) ABSTRACT

A method of manufacturing a folded body of an airbag, which is inflated by allowing an inflation gas, including: an inflow opening through which the inflation gas is allowed to flow; and an attachment portion of the circumferential edge of the inflow opening, the airbag being formed as a folded body having a folded shape of being gathered to an upper side of the attachment portion, the attachment portion being attached to an attachment seat of a storage portion, the method includes: folding the airbag, in the state of raising a temperature of the airbag, to form a pre-folded body; heating and compressing the pre-folded body, and cooling and compressing the pre-folded body, which is heated and compressed, to form the folded body.

### CROSS-REFERENCE TO RELATED APPLICATION(S)

This application is based upon and claims the benefit of priority from Japanese Patent Application No. 2015-223409, filed on Nov. 13, 2015, the entire contents of which are incorporated herein by reference.

### BACKGROUND

1. Field of the Invention

The present invention relates to a method of manufacturing a folded body of an airbag which folds an airbag to be attachable in a storage portion, and manufactures the folded airbag by the compression molding to maintain the folded shape, and to a method of manufacturing a folded body of an airbag which can be used in a driver seat airbag device, a passenger seat airbag device, and the like.

2. Description of the Related Art

In such a kind of airbag folded body according to the related art, an airbag includes an inflow opening through which the inflation gas is allowed to flow, and an attachment portion of the circumferential edge of the inflow opening (for example, see JP-A-2007-261565). The attachment portion is arranged with a retainer therein in order to attach the airbag folded body to a storage portion. The folded body formed by folding the airbag has a compact folded shape that is folded to be gathered to the upper side of the attachment portion of the circumferential edge of the inflow opening.

In another airbag folded body, in order to maintain the compact folded shape, after folding the airbag, the folded body is heated and compressed, and is cooled with the compressed state maintained. Therefore, the airbag folded body is manufactured to have a shape retention property that folding collapse does not occur easily. (for example, see JP-A-2015-520065).

However, in the conventional airbag folded body, there is not enough time to maintain the folded shape, and the folding collapse occurs easily. Thus, there is a problem in manufacturing an airbag folded body having durability to maintain the folded shape for a long time.

### SUMMARY

The invention is made to solve the above-described problems, and an object thereof is to provide a method of manufacturing a folded body of an airbag which can manufacture a folded shape to be maintainable for a long time.

According to an aspect of the invention, there is provided a method of manufacturing a folded body of an airbag, which is inflated by allowing an inflation gas, including: an inflow opening through which the inflation gas is allowed to flow; and an attachment portion of the circumferential edge of the inflow opening, the airbag being formed as a folded body having a folded shape of being gathered to an upper side of the attachment portion, the attachment portion being attached to an attachment seat of a storage portion, the method including: folding the airbag, in the state of raising a temperature of the airbag, to form a pre-folded body; heating and compressing the pre-folded body, and cooling and compressing the pre-folded body, which is heated and compressed, to form the folded body.

In a method of manufacturing a folded body of an airbag according to the invention, the folded body is manufactured in such a manner that the pre-folded body is formed by folding the airbag by the folding process in the state of raising the temperature thereof, and the pre-folded body is heated and compressed and is cooled with maintaining the compressed state by a heating compression process and a cooling compression process. That is, in the folding process, the airbag is folded with the temperature raised, and thus the inside of the pre-folded body also is heated. Therefore, the entire pre-folded body, which is from the inside of the pre-folded body to the external surface, becomes easy to be firmed in a predetermined folded shape of the folded body in a next heating compression process. After that, cooling is performed with the compressed state maintained. Thus, it is possible to obtain the folded body which has durability that can maintain the firmed folded shape for a long time without folding collapse.

Therefore, in the method of manufacturing the airbag folded body according to the invention, it is possible to manufacture the folded shape to be maintainable for a long time.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a schematic plan view illustrating a steering wheel on which an airbag device storing a completely folded body of an embodiment of the invention is mounted;

FIG. 2 is a schematic longitudinal sectional view illustrating the steering wheel storing the completely folded body of the embodiment, and corresponds to II-II portion of FIG. 1;

FIG. 3 is a schematic longitudinal sectional view illustrating the steering wheel storing the completely folded body of the embodiment, and corresponds to portion of FIG. 1;

FIG. 4 is a schematic longitudinal sectional view illustrating the steering wheel storing the completely folded body of the embodiment, and corresponds to IV-IV portion of FIG. 1;

FIGS. 5A and 5B are a schematic plan view and a schematic sectional view illustrating a state where an airbag of the completely folded body of the embodiment is completely inflated as a single unit;

FIG. 6 is a schematic partially longitudinal sectional view illustrating the folded body assembled with a retainer of the embodiment;

FIG. 7 is a schematic front view illustrating the folded body assembled with the retainer of the embodiment;

FIG. 8 is a schematic perspective view illustrating the folded body assembled with the retainer of the embodiment;

FIG. 9 is a schematic bottom surface view illustrating the folded body assembled with the retainer of the embodiment;

FIG. 10 is a schematic plan view illustrating an airbag folding machine to be used in a folding process of the airbag of the embodiment;

FIG. 11 is a schematic sectional view illustrating the airbag folding machine to be used in a folding process of the airbag of the embodiment;

FIG. 12 is a diagram illustrating a folding process of the airbag of the embodiment;

FIG. 13 is a diagram illustrating a folding process of the airbag of the embodiment, and illustrates a process subsequent to the process of FIG. 12;

FIG. 14 is a diagram illustrating a heating and compression process in which the airbag of the embodiment is formed;

FIG. 15 is a diagram illustrating the heating and compression process in which the airbag of the embodiment is formed, and illustrates a process subsequent to the process of FIG. 14;

FIG. 16 is a diagram illustrating a cooling and compression process in which the airbag of the embodiment is formed, and illustrates a process subsequent to the process of FIG. 15;

FIG. 17 is a diagram illustrating the cooling and compression process in which the airbag of the embodiment is formed, and illustrates a process subsequent to the process of FIG. 16;

FIG. 18 is a schematic longitudinal sectional view illustrating an airbag device storing a folded body of a modification example of the embodiment;

FIG. 19 is a diagram illustrating a heating and compression process for producing the folded body illustrated in FIG. 18; and

FIG. 20 is a diagram illustrating a heating and compression process for producing the folded body illustrated in FIG. 18, and illustrates a process subsequent to the process of FIG. 19.

### DETAILED DESCRIPTION OF THE INVENTION

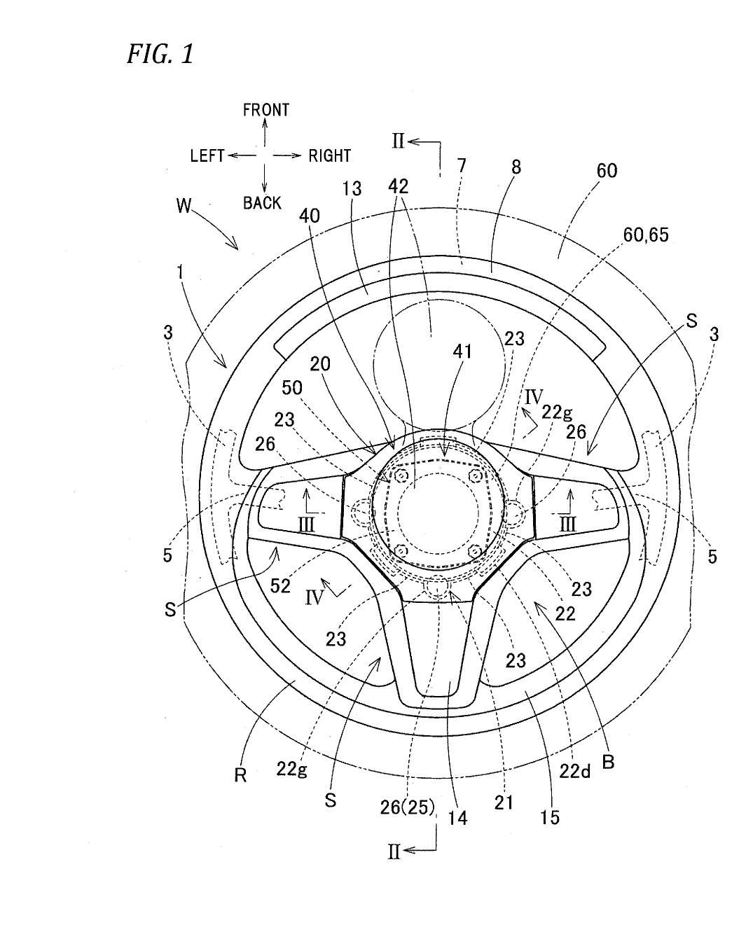

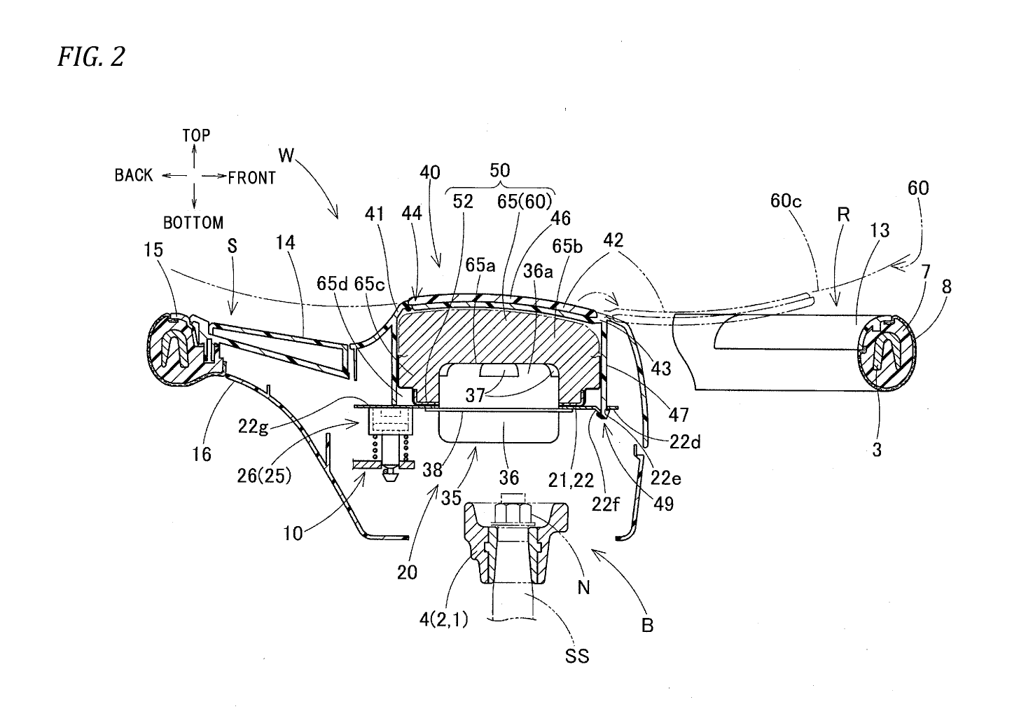

Hereinafter, an embodiment of the invention will be described with reference to drawings. As illustrated in FIGS. 1 to 4, a folded body 65 of an airbag 60 of the embodiment is used to a driver's airbag device 20 mounted on a boss portion B of a steering wheel W. As illustrated in FIGS. 1 and 2, the steering wheel W includes a steering wheel body 1 including a ring portion R which is gripped at the time of steering, the boss portion B disposed in the center of the ring portion R, and a spoke portion S connecting the ring portion R and the boss portion B, and the airbag device 20 arranged on the upper portion of the boss portion B.

In the present specification, a vertical direction, a right-left direction, and a front-rear direction of the airbag device 20, the folded body 65, the steering wheel W, and the like are based on when a vehicle is steered straight ahead in a state where the steering wheel W is connected to a steering shaft SS (see FIG. 2) of the vehicle by fixing with a nut N. The vertical direction corresponds to a vertical direction along the axial direction of the steering shaft SS. The right-left direction corresponds to a right-left direction of the vehicle which is the axis orthogonal direction of the steering shaft SS. The front-rear direction corresponds to a front-rear direction of the vehicle which is the axis orthogonal direction of the steering shaft SS (see FIGS. 1 and 2).

The steering wheel body 1 includes a cored bar 2 arranged so as to connect the ring portion R, the boss portion B, and the spoke portion S to each other, and a coating layer 7 which is made of urethane and the like, and covers the ring portion R and the cored bar 2 of the spoke portion S near the ring portion R. A leather 8 is wound on the surface of the coating layer 7. Decorative garnishes 13 and 15 are arranged on the inner circumferential side of the front portion and the rear portion of the ring portion R.

The cored bar 2 includes a ring cored bar 3 disposed in the ring portion R, a boss cored bar 4 disposed to the boss portion B so as to be connected with the steering shaft SS, and a spoke cored bar 5 disposed to the right and left spoke portions S so as to connect the ring cored bar 3 and the boss cored bar 4. In the case of the embodiment, the spoke cored bars 5 are arranged only in the two right and left spoke portions S on the front side. A bezel 14 enclosing the periphery of an airbag cover (to be illustrated later, pad) 40 is arranged the spoke portion S on the rear side.

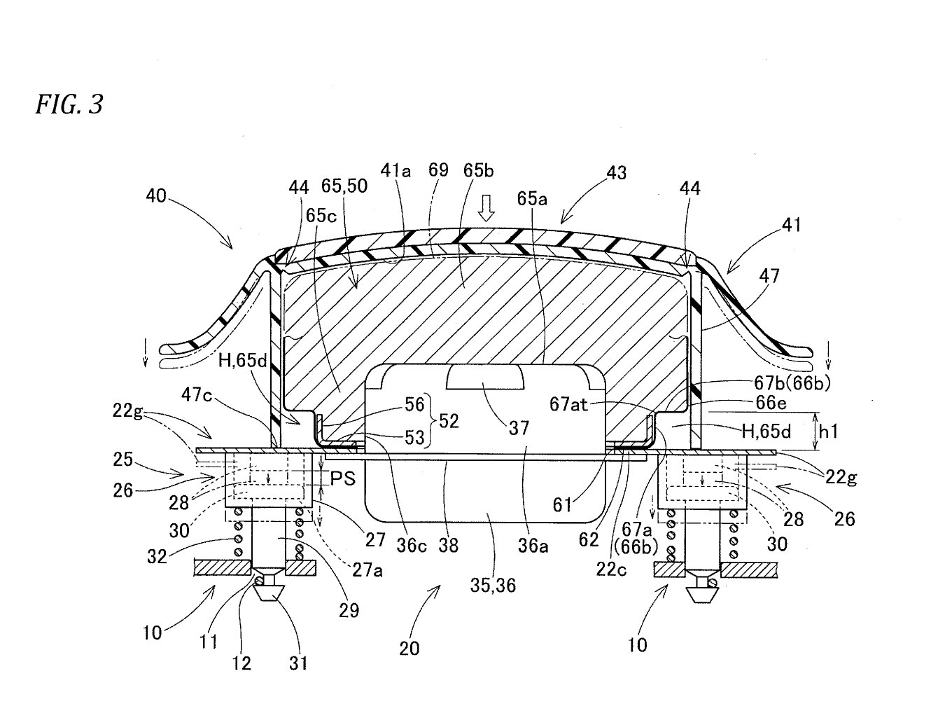

A fixing portion 10 which fixes each assembly pin 29 of a horn switch mechanism 25 (to be described later) of the airbag device 20 is arranged in the circumferential edge of the boss cored bar 4 of the cored bar 2 (see FIGS. 2 and 3). The fixing portion 10 includes a locking hole 11 which is penetrated in a tapered shape of narrowing downward, and a locking pin 12 which is disposed on the lower surface of the boss cored bar 4 and locks a locking head 31 of the assembly pin 29. The locking pin 12 is formed of a bendable spring to be restorable and along the lower surface of the boss cored bar 4.

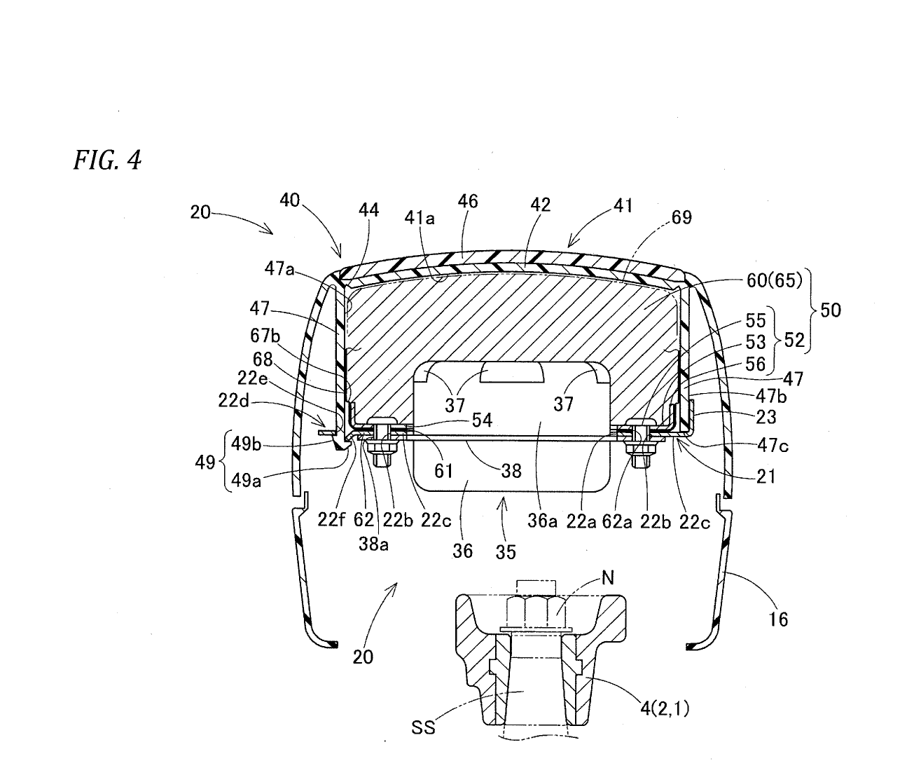

The steering wheel body 1 is configured such that a lower cover 16 is arranged on the lower surface of the boss portion B (see FIGS. 2 and 4).

As illustrated in FIGS. 1 to 4, the airbag device 20 includes the folded body 65 of the airbag 60, an inflator 35 which supplies an inflation gas to the airbag 60, the airbag cover (pad) 40 which is made of synthetic resin, and is disposed on the upper surface of the boss portion B to cover the folded body 65, and an airbag holder 21 which is made of a metal and functions as a storage portion holding the folded body 65 (the airbag 60). The airbag holder 21 is a portion for attaching and fixing the folded body 65, and also a portion which holds the inflator 35 and the airbag cover 40.

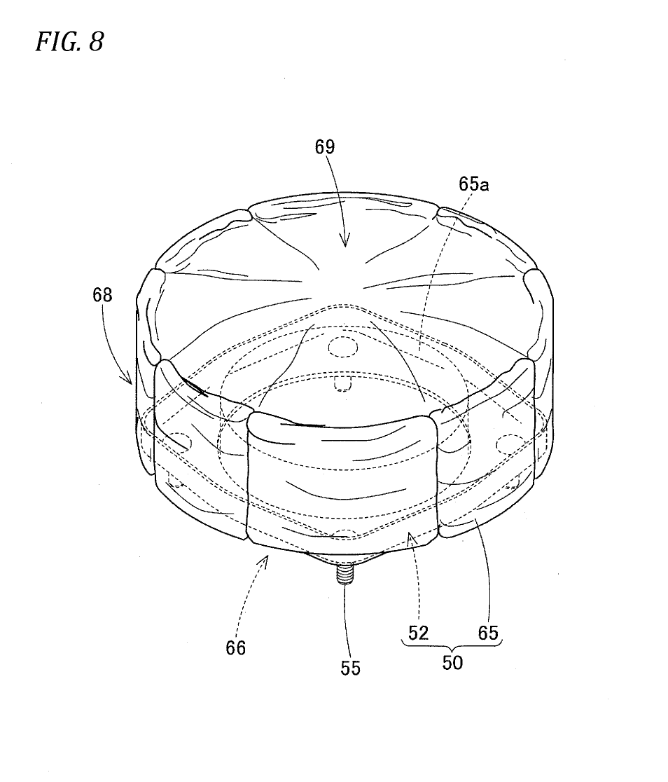

In the case of the embodiment, the retainer 52 which the airbag 60 is fixedly attached to the airbag holder 21 is arranged inside the folded body 65 formed by folding the airbag 60 on the bottom surface 66 side (FIGS. 2 to 4 and 6 to 9). The airbag 60 is folded and compressed with being assembled with the retainer 52. For this reason, when the folded body 65 of the airbag 60 is compression molded to be formed in a predetermined folded shape, the retainer 52 is assembled to the folded body 65 of the airbag 60 (completely folded body 50), the completely folded body 50 including the retainer 52 and the folded body 65 of the airbag 60 is fixedly attached to the airbag holder 21.

As illustrated in two-dot chain lines of FIGS. 1 and 2 and FIGS. 5A and 5B, the airbag 60 has a completely-inflated shape which is close to a spherical shape, is thick, and is an approximately disc shape, and includes an inflow opening 61 which is circularly open downward to allow the inflation gas to flow therein (see FIGS. 3 to 5B). Four through holes 62a through which bolts 55 as a fixing unit of the retainer 52 penetrate are formed in a circumferential edge 62 of the inflow opening 61. A circumferential wall 60a of the airbag 60 is configured by suturing the outer circumferential edges of a driver-side panel 60b and a vehicle-side panel 60c which have a circular outer shape. The inflow opening 61 is arranged in the center of a vehicle body-side panel 60c. The circumferential edge 62 of the inflow opening 61 is pressed by the retainer 52, and forms an attachment portion for attaching the airbag 60 to the airbag holder 21. The attachment portion 62 is an approximately quadrangular annular portion having a lower surface abutting on a lower surface 53c of a bottom wall portion 53 (to be described later) of the retainer 52. The lower surface serves as a bottom wall cover portion 66a (to be described later) of the folded body 65 formed by folding the airbag 60.

The attachment portion 62 and a portion 63 adjacent thereto are arranged with a reinforced fabric (not illustrated) for improving strength, and are configured in a sheet shape of a single plate with the vehicle-side panel 60c.

As illustrated in FIGS. 1 to 6, and 9, the retainer 52 is formed of a metal plate including a quadrangular annular bottom wall portion 53 having a communication opening 54, which is open in correspondence to the inflow opening 61, in the center, and a reinforcing rib 56 arranged to stand from the entire circumference of the outer circumferential edge of the bottom wall portion 53. The reinforcing rib 56 is arranged so as to improve a bending rigidity of the bottom wall portion 53. The communication opening 54 is a circular opening of the same shape as the inflow opening 61. The retainer 52 protrudes downward from the bottom wall portion 53 around the communication opening 54 with being centered on the communication opening 54, and includes the bolts 55 as a plurality of fixing units which is configured to fix the attachment portion 62 of the airbag 60 to the airbag holder 21. Each bolt 55 projects downward from the vicinity of each of four corner portions 53a of the quadrangular annular bottom wall portion 53. The retainer 52 is arranged in the circumferential edge (attachment portion) 62 of the inflow opening 61 in the airbag 60. Each bolt 55 penetrates through the through hole 62a of the airbag 60, a through hole 22b (to be described later) of the airbag holder 21, and a through hole 38a of a flange portion 38 (to be described later) of the inflator 35 in order. The airbag 60 and the inflator 35 are attached to the airbag holder 21 by tightening the nut 58 to the bolt 55.

A process of manufacturing the folded body 65 assembled with the retainer 52 includes three processes of the folding process, the heating compression process, and the cooling compression process.

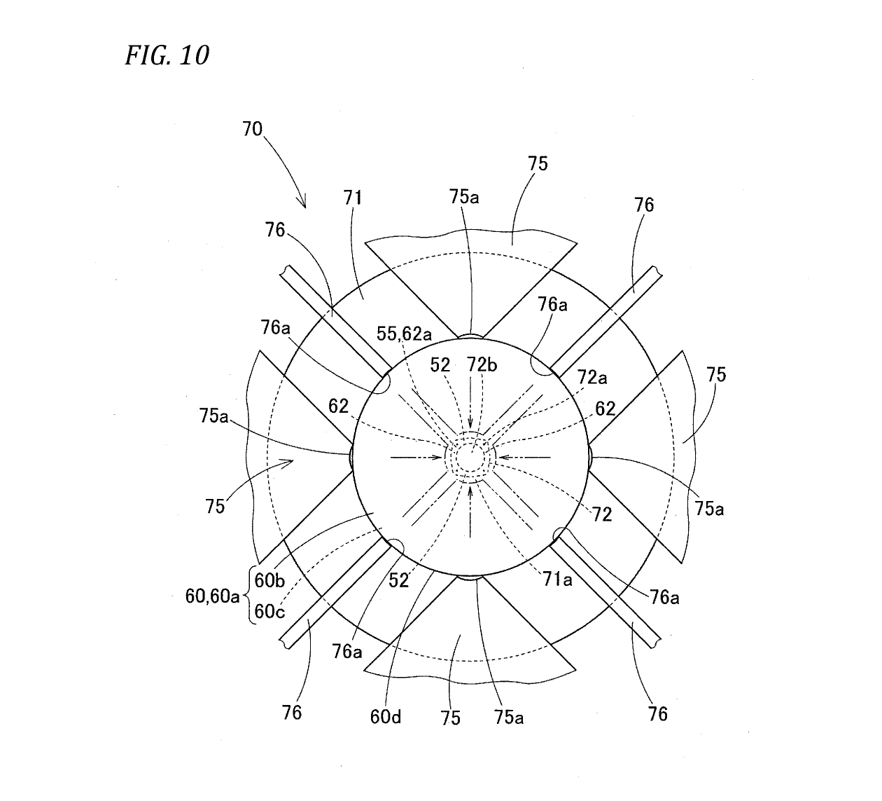

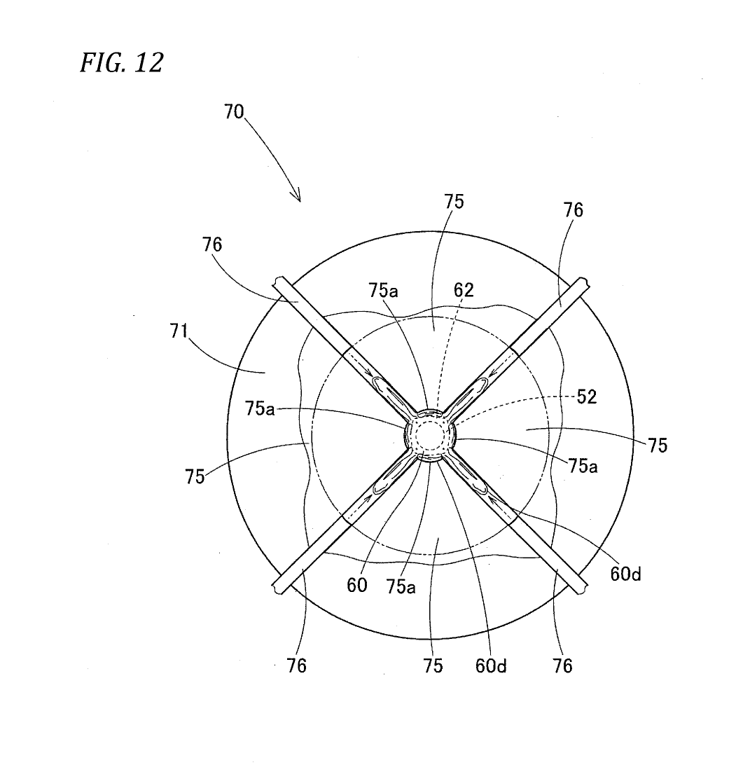

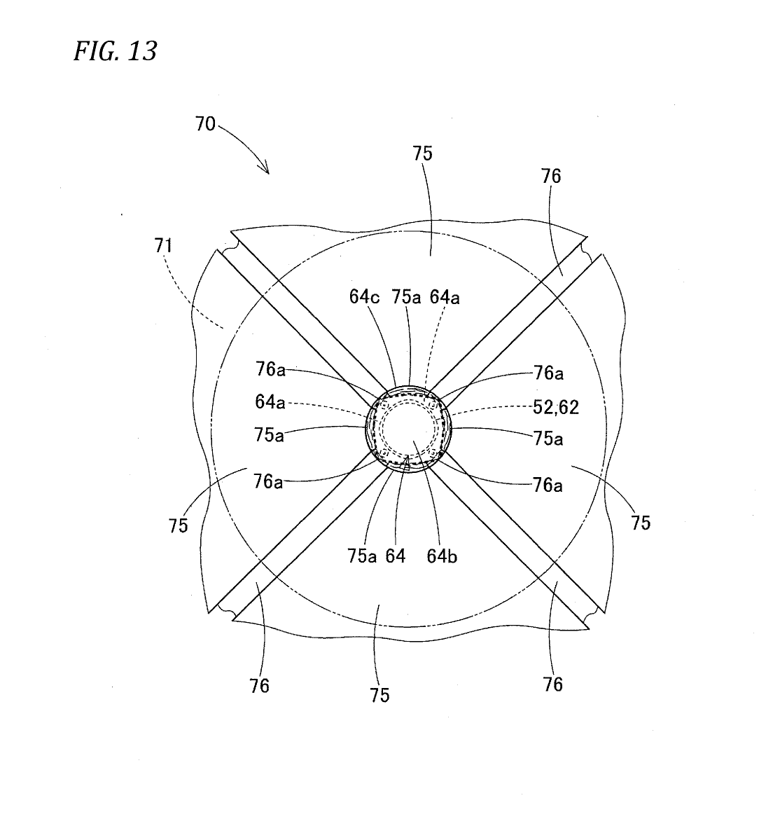

When simply describing the folding process, first, as illustrated in FIG. 10, each bolt 55 protrudes from the through hole 62a, and the retainer 52 is arranged to the attachment portion 62 in the airbag 60. Then, the airbag 60 is flattened with the driver-side panel 60b overlapped on the vehicle-side panel 60c, and is set in an airbag folding machine 70. Then, as illustrated in FIGS. 12 and 13, the outer circumferential edge 60d of the airbag 60 is gathered to the upper side of the retainer 52, and a pre-folded body 64 formed by folding the airbag 60 is formed on the upper side of the bottom wall portion 53 of the retainer 52.

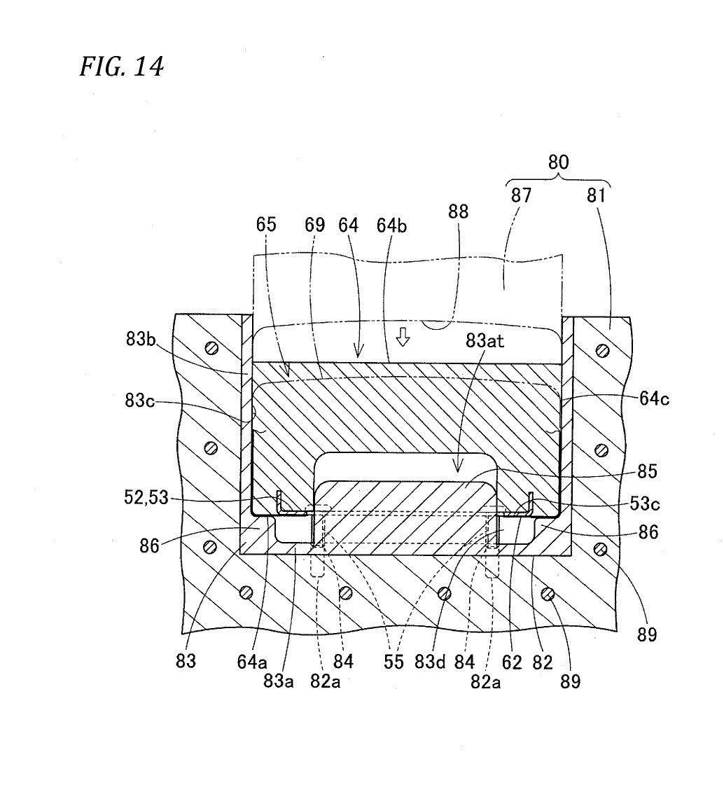

When the compression process such as the heating compression process and the cooling compression process is briefly described, as illustrated in FIGS. 14 to 17, a storage recess portions 65a or 65d for storing is provided in the pre-folded body 64 using airbag molding machines 80 and 90 (to be described later), and when a compression working to maintain the folded shape is performed, it is possible to manufacture an approximately columnar folded body 65.

The folded body 65 manufactured in this manner has a shape retention property to support the ceiling wall portion 41 of the airbag cover 40. Specifically, the folded body 65 has a lower rigidity than the airbag holder 21 and the retainer 52 which are made of a metal plate. However, the folded body 65 has the shape retention property with a higher rigidity than the airbag cover 40, and has such a rigidity that folding collapse does not occur and recess almost does not occurs to retain an approximately columnar outer shape although the folded body is inclined obliquely, is inverted vertically, or is pressed partially. Of course, the folded body 65 has a shape retention property within a range for allowing deployment and inflation of the airbag 60 at the time of inflow of the inflation gas.

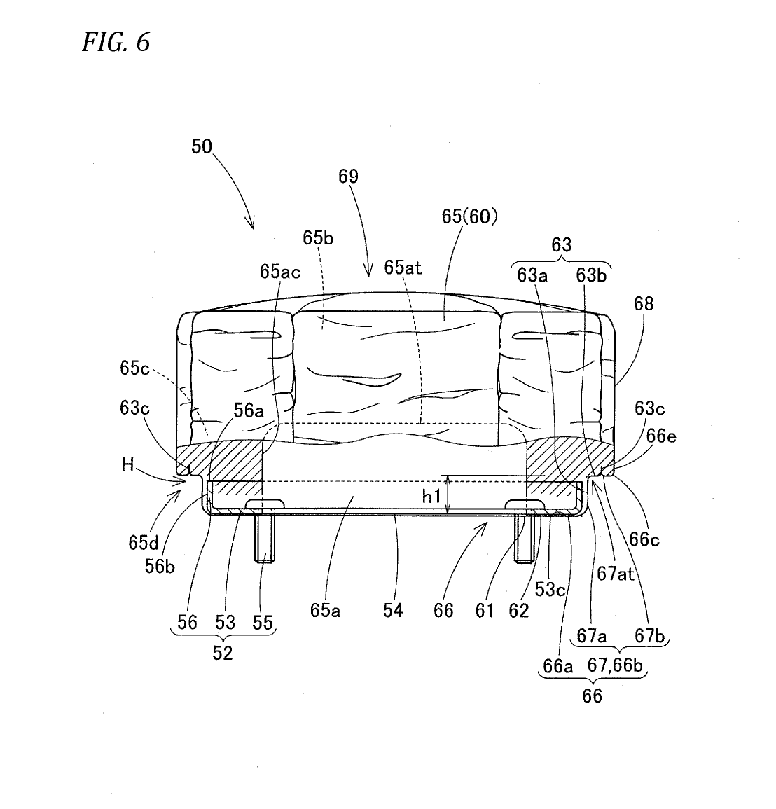

As illustrated in FIGS. 6 to 9, the folded body 65 has an approximately columnar shape having a storage recess portion 65a on a bottom surface 66 side. The folded body 65 includes an approximately disc-shaped upper wall portion 65b, which clogs the upper side of the storage recess portion 65a, on an upper surface 69 side, and an approximately cylindrical side-wall portion 65c which extends downward from the upper wall portion 65b to enclose the periphery of the storage recess portion 65a. The storage recess portion 65a is formed to be concave upward from the center of the bottom surface 66 of the folded body 65. The storage recess portion 65a includes an inner circumferential surface 65ac, which has a cylindrical shape with the same inner diameter as that of the communication opening 54 of a retainer 52 and extends upward, and an approximately circular ceiling surface 65at which is disposed in the upper end of the inner circumferential surface 65ac. The storage recess portion 65a is formed to be capable of storing an upper portion 36a of a main body portion 36 (to be described later) of an inflator 35.

As illustrated in FIGS. 3 and 4, the upper surface 69 of the folded body 65 (upper wall portion 65b) is a curved surface corresponding to a lower surface 41a of a ceiling wall portion 41 of an airbag cover 40.

In the bottom surface 66 of the folded body 65, a bottom wall portion 53 of the retainer 52 is arranged in the circumferential edge (attachment portion) 62 of the inflow opening 61 on the inner circumferential surface side of an airbag 60 in a state where each bolt 55 protrudes through a through hole 62a. For this reason, when the folded body 65 having a shape retention property is fixedly attached to an airbag holder 21, the upper wall portion 65b of the folded body 65 is supported in a contact with the airbag holder 21 via the side wall portion 65c storing the retainer 52 on the lower end side of the side wall portion 65c therein.

A stepped surface 67 is provided on the lower end side of the side wall portion 65c of the folded body 65 to form the recess portion 65d which is concave annularly. The recess portion 65d is formed in order to prevent that a portion of a circumferential wall 60a except the attachment portion 62 of the airbag 60 is jammed between the airbag holder 21 and the retainer 52.

Except the opening (inflow opening) 61 of the storage recess portion 65a, the bottom surface 66 of the folded body 65 near the recess portion 65d is arranged with a bottom wall cover portion 66a which is disposed on a lower surface 53c of the bottom wall portion 53 of the retainer 52, and a bottom wall separated portion 66b which extends from the bottom wall cover portion 66a and is disposed around the bottom wall portion 53 of the retainer 52.

A portion, which is connected from the bottom wall cover portion 66a, of the bottom wall separated portion 66b includes the stepped surface 67. The stepped surface 67 includes a vertical surface 67a bent upward from the bottom wall cover portion 66a, and a horizontal surface 67b which is disposed on the upper side of the bottom wall cover portion 66a from the upper end 67at of the vertical surface 67a and extends toward the outer circumferential edge 66c of the bottom wall separated portion 66b. In this embodiment, the horizontal surface 67b is configured in parallel with the bottom wall portion 53 and the bottom wall cover portion 66a.

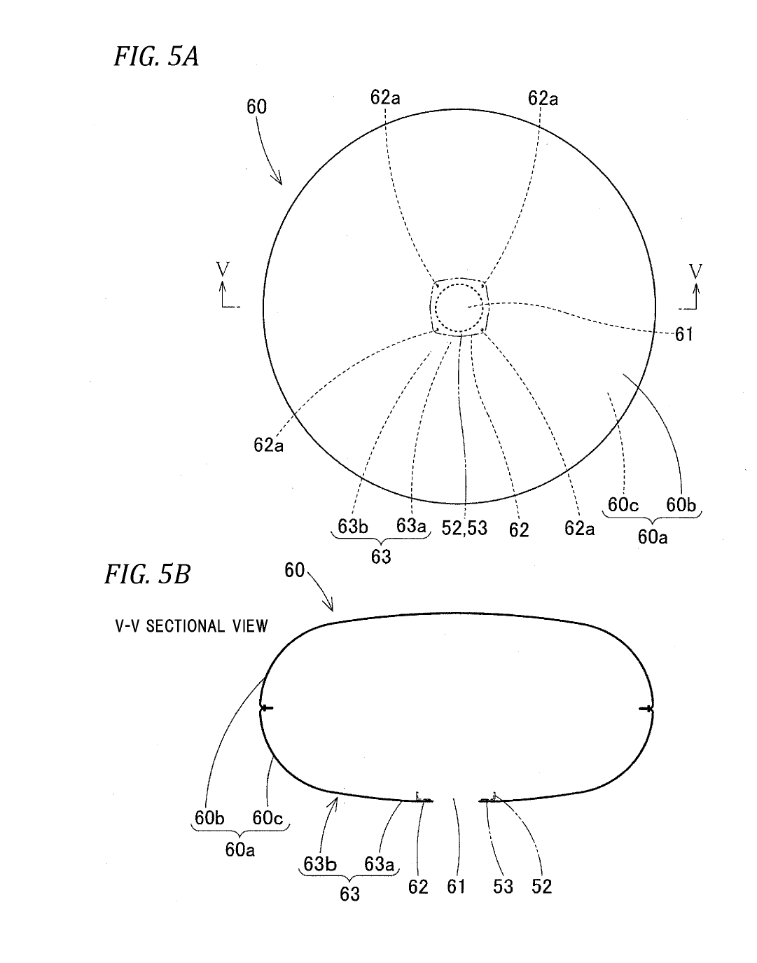

A portion, which forms the bottom wall cover portion 66a, of the airbag 60 is the attachment portion 62 which is the circumferential edge of the inflow opening 61 in the vehicle-side panel 60c of the airbag 60 (see FIGS. 5A to 7, and 9). The attachment portion 62 has a single sheet shape without a wrinkle or a crease, and is arranged in close contact with the lower surface 53c of the bottom wall portion 53 of the retainer 52. The lower surface of the attachment portion 62 forms the bottom wall cover portion 66a.

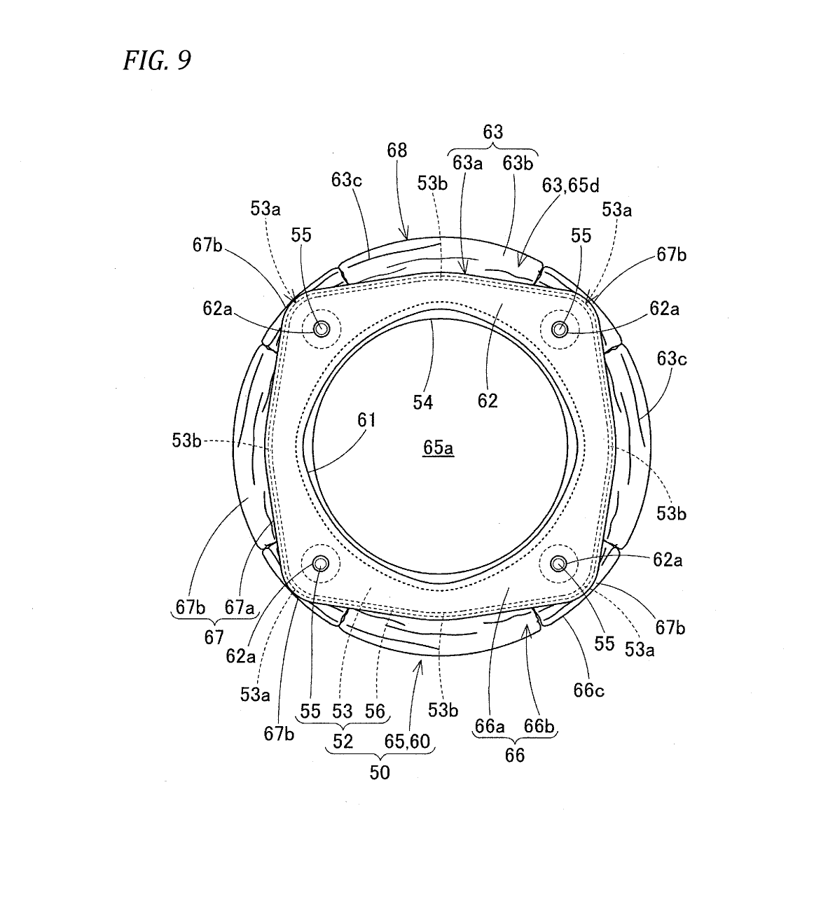

A portion, which forms the bottom wall separated portion 66b, of the airbag 60 is a neighboring portion 63 in vicinity of the attachment portion 62 extending from the attachment portion 62 of the airbag 60 (see FIGS. 5A to 7, and 9). The vertical surface 67a and the horizontal surface 67b are formed from the external surface of the neighboring portion 63. A portion disposed to be in close contact with an external surface (outer circumferential surface) 56b of the reinforcing rib 56 of the retainer 52 is configured from an inner portion 63a of the neighboring portion 63 connected to the attachment portion 62. The vertical surface 67a is formed from the external surface. Herein, the horizontal surface 67b is configured from a lower surface obtained by forming the neighboring portion 63 in a planar shape when viewed in the right-left and front-rear directions of the folded body 65, so that a height dimension hl from the bottom wall cover portion 66a is constant. However, actually, the bottom surface 66 of the folded body 65 is configured to provide a wrinkle portion 63c formed by folding an outer portion 63b around the inner portion 63a of the neighboring portion 63 partially in the right-left and front-rear directions (see FIGS. 6 and 9). In the case of the embodiment, FIGS. 3, 4, 6, and the like illustrate a state of providing a gap. However, actually, the inner portion 63a, which is connected to the attachment portion 62, of the neighboring portion 63 has a single sheet shape without a wrinkle and a crease, and is in close contact with the outer surface (outer circumferential surface) 56b of the reinforcing rib 56 of the retainer 52.

In the case of the embodiment, the horizontal surface 67b of the stepped surface 67 is disposed at a position slightly higher than an upper end surface 56a of the reinforcing rib 56 of the retainer 52. The horizontal surface 67b on the outer circumferential side of the reinforcing rib 56 of the corner portion 53a of the retainer 52 is arranged as a small area (see FIGS. 4 and 9).

As illustrated in FIGS. 2 to 4, the inflator 35 includes the columnar main body portion 36, and the quadrangular annular flange portion 38 projects from the outer circumferential surface of the main body portion 36. The through hole 38a through which the bolt 55 of the retainer 52 penetrates is formed in the flange portion 38. A plurality of gas discharge outlets 37 discharging an inflation gas are arranged in the upper portion 36a of the flange portion 38 of the main body portion 36. When the completely folded body 50 including the retainer 52 and the folded body 65 and the inflator 35 are fixed in the airbag holder 21, as described above, the upper portion 36a is inserted into the storage recess portion 65a of the completely folded body (folded body 65) 50 through the communication opening 54 of the retainer 52 and the inflow opening 61 of the airbag 60.

As illustrated in FIGS. 1 to 4, the airbag cover 40 is made of synthetic resin such as an olefin-based thermoplastic elastomer (TPO), and is arranged on the upper surface of the boss portion B near the center of the steering wheel W. The airbag cover 40 includes the ceiling wall portion 41 which covers the upper side of the completely folded body 50 stored inside the boss portion B in the state of being folded, and a side wall portion 47 which extends in an approximately cylindrical shape from the lower surface 41a of the ceiling wall portion 41, and covers the side surface (outer circumferential surface) 68 of the approximately columnar completely folded body 50 (folded body 65).

A disc-shaped door portion 42 which is openable forward by being pressed by the inflated airbag 60 is arranged in the ceiling wall portion 41. The door portion 42 is provided with a hinge portion 43 on the front edge side, and a thin rupture expected portion 44 which has an approximately arc shape in top view is provided therearound.

In the case of the embodiment, a synthetic-resin ornament 46 with an approximately disc shape is firmly fixed on the upper surface side of the door portion 42. When the door portion 42 is opened, the ornament 46 rotates integrally with the door portion 42.

As illustrated in FIGS. 1 and 4, locking leg portions 49 coupled with the airbag holder 21 are arranged at three positions which are the front side and obliquely rear sides of right and left sides of the side wall portion 47 of the airbag cover 40. Each locking leg portion 49 projects to extends downward from a lower end surface 47c of the side wall portion 47, and is inserted into a locking hole 22e of the airbag holder 21 to be locked to the circumferential edge of the locking hole 22e. The locking leg portion 49 includes an inner protrusion 49a protruding from an inner circumferential surface 47a of the side wall portion 47 and an outer protrusion 49b protruding from an outer circumferential surface 47b of the side wall portion 47. After the locking leg portion 49 is inserted into the locking hole 22e, the inner protrusion 49a is locked by a tongue portion 22f deformed by bending, and the locking leg portion 49 is pressed by the tongue portion 22f The outer protrusion 49b is locked by the circumferential edge of the outer edge side, which is separated from the inflator 35, of the locking hole 22e, whereby the airbag cover 40 is regulated not to come out upward so as to be locked in the airbag holder 21.

The side wall portion 47 is configured such that the lower end surface 47c between the locking leg portions 49 and 49 abuts on a base plate portion 22 of the airbag holder 21, and the locking leg portion 49 regulates the upward movement of the airbag holder 21. Therefore, the airbag cover 40 is fixedly attached to the airbag holder 21, whereby the vertical movement and front-rear and right-left movement of the airbag cover 40 is regulated.

The airbag holder 21 is made of metal plate. As illustrated in FIGS. 1 to 4, the airbag holder 21 holds the completely folded body 50 (folded body 65), the inflator 35, and the airbag cover 40. The airbag holder 21 is configured as a metal plate member which attaches the airbag device 20 to the steering wheel body 1 by using the switch body 26. The airbag holder 21 includes the approximately annular base plate portion 22, and a side wall support portion 23 protruding upward from the outer circumferential edge of the base plate portion 22.

Locking portions 22d formed by penetrating the locking hole 22e provided with the tongue portion 22f are arranged in the front side and obliquely rear sides of right and left sides of the base plate portion 22. Approximately semi disc-shaped switch support portions 22g which fix each switch body 26 are arranged on the rear side and both of right and left side. The side wall support portion 23 is arranged in the outer circumferential surface 47b of the side wall portion 47 of the airbag cover 40 between the locking portion 22d and the switch support portion 22g. The side wall support portion 23 regulates the deformation of inflating the side wall portion 47 at the time of inflation of the airbag 60.

An approximately circular insertion hole 22a through which the lower side of the main body portion 36 of the inflator 35 is insertable and which corresponds to the inflow opening 61 of the airbag 60 is open in the center of the base plate portion 22. The four through holes 22b through which the bolts 55 of the retainer 52 penetrate is formed in the circumferential edge of the insertion hole 22a. The portion, which is provided with the through hole 22b, of the circumferential edge of the insertion hole 22a, serves as an attachment seat 22c for attaching the completely folded body 50 and the inflator 35 by using the retainer 52.

Three switch bodies 26 arranged in the switch support portions 22g form the horn switch mechanism (horn switch) 25 of the steering wheel W. As illustrated in FIGS. 2 and 3, the switch body 26 includes an approximately cylindrical cover 27, a moving-side contact portion 28, the assembly pin 29, and a coil spring 32. The cover 27 and the moving-side contact portion 28 are arranged in the switch support portion 22g of the airbag holder 21. The coil spring 32 is arranged between the fixing portion 10 of the cored bar 2 and the cover 27 so as to bias the cover 27 upward. The assembly pin 29 is arranged with a fixing-side contact portion 30 in the cover 27 such that the fixing-side contact portion 30 faces the moving-side contact portion 28 in the vertical direction. The locking head 31 on the lower end side is locked to the locking pin 12 arranged to the locking hole 11. The fixing-side contact portion 30 abuts on the upper surface of a bottom wall portion 27a in the cover 27 so that the fixing-side contact portion 30 is prevented from coming out downward from the cover 27. The locking pin 12 regulates that the assembly pin 29 comes out upward from the locking hole 11, and the bottom wall portion 27a of the cover 27 biased upward from the coil spring 32 regulates the downward movement of the fixing-side contact portion 30, whereby the vertical movement of the assembly pin 29 is regulated. Therefore, the assembly pin 29 is arranged to be fixed to the fixing portion 10 of the cored bar 2.

The moving-side contact portion 28 is conductive to the positive electrode of a horn operating circuit connected to the base plate portion 22. The fixing-side contact portion 30 is conductive to the cored bar 2 as a negative electrode of the horn operating circuit by interposing the locking head 31 and the locking pin 12 therebetween. For this reason, the airbag cover (pad) 40 and the airbag device 20 descend by an operating stroke (separation distance of contact portions 28 and 30) PS. Each switch body 26 of the horn switch mechanism 25 allows the moving-side contact portion 28 to descend together with the base plate portion 22 of the airbag holder 21 so that the moving-side contact portion 28 contacts the fixing-side contact portion 30, thereby operating a horn.

Specifically, when the vicinity of the center of the ceiling wall portion 41 of the airbag cover 40 is operated to be pressed downward, the ceiling wall portion 41 abuts on the upper surface 69 of the folded body 65 having the shape retention property to support the ceiling wall portion 41, the folded body 65 is pressed downward, and the folded body 65 moving downward allows the airbag holder 21 abutting on the lower surface (bottom surface) 66 of the side wall portion 65c to descend. For this reason, the airbag holder 21 allows the moving-side contact portion 28 of the switch body 26 to descend together with the base plate portion 22 so that the moving-side contact portion 28 contacts the fixing-side contact portion 30, thereby operating a horn.

When describing a process to form the folded body 65 of the airbag 60, as described above, the folded body 65 with an approximately columnar shape having the storage recess portion 65a and the recess portion 65d is formed by the folding process to form the pre-folded body 64 by folding the airbag 60 by using the airbag folding machine 70 illustrated in FIGS. 10 to 13 and the compressing process (heating compression process and the cooling compression process) to compress the pre-folded body 64 having gone through the folding process by using the airbag molding machines 80 and 90 illustrated in FIGS. 14 to 17.

As illustrated in FIGS. 10 to 13, the airbag folding machine 70 includes a substrate 71, a ceiling wall portion 73 which is arranged to be vertically movable above the substrate 71, and two types of four pressing tools 75 and 76 which move to the center of the substrate 71 on the substrate 71. A set portion 72 having an assembly hole 72a into which each bolt 55 of the retainer 52 protruding from the airbag 60 is fitted is arranged in the center of the upper surface of the substrate 71. The set portion 72 on the upper surface of the substrate 71 serves as a molding surface 71a which forms the bottom surface 66 (bottom surface 64a of pre-folded body 64) before providing the storage recess portion 65a or 65d of the folded body 65 of the airbag 60. The vicinity of the center of the lower surface of the ceiling wall portion 73 serves as a molding surface 73a which forms the upper surface 69 (a planar ceiling surface 64b of the pre-folded body 64) before providing the recess portion 65a or 65d of the folded body 65. An approximately columnar convex portion 72b is arranged in the set portion 72 such that the storage recess portion 65a for storing the upper portion 36a of the inflator 35 is easily formed in the folded body 65. The set portion 72 is configured to reliably hold the bolt 55 of the retainer 52 so that a portion except the attachment portion 62 of the airbag 60 does not enter the lower surface 53c of the bottom wall portion 53 of the retainer 52 at the time of folding process.

The pressing tools 75 and 76 are alternately arranged in a circumferential direction centered on the set portion 72. Arc-shaped molding surfaces 75a and 76a which form the outer circumferential surface 68 (an outer circumferential surface 64c of the pre-folded body 64) before providing the recess portion 65a or 65d of the folded body 65 are formed on the surface of the pressing tools 75 and 76 on the set portion 72 side.

A heater 78 as a heating unit is arranged in the substrate 71 and the ceiling wall portion 73 such that the temperature of the set airbag 60 can rise to 50° C. or more (about 50 to 90° C.). The heater 78 is properly arranged also in the pressing tools 75 and 76.

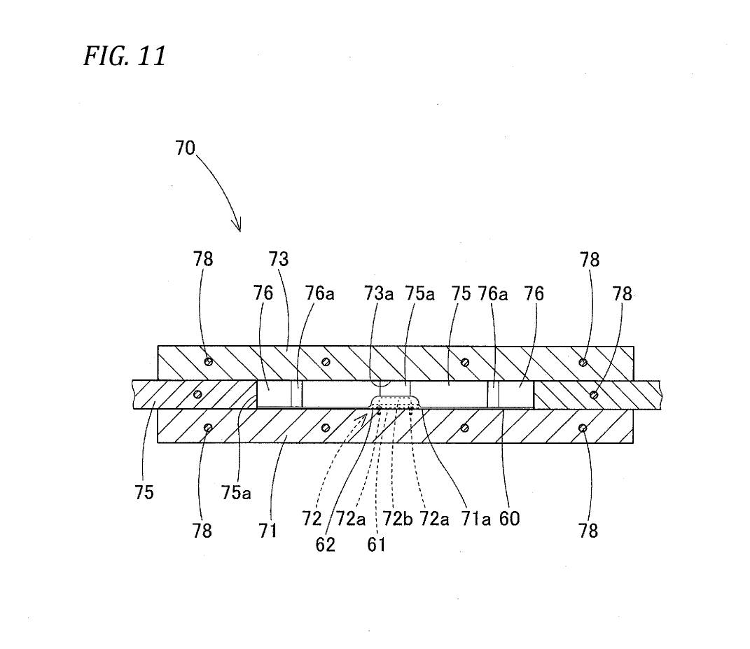

At the time of using the airbag folding machine 70, in advance, each bolt 55 is set to protrude from the through hole 62a, and the retainer 52 is arranged in the attachment portion 62 of the airbag 60. As illustrated in FIG. 10, each bolt 55 is fitted into the assembly hole 72a of the set portion 72, the driver-side panel 60b is overlapped on the vehicle-side panel 60c, and the airbag 60 becomes in the state of being in parallel on the substrate 71. Then, the ceiling wall portion 73 is disposed at a position of a predetermined height from the substrate 71 to form the ceiling surface 64b of the pre-folded body 64 (see FIG. 11). As illustrated in FIG. 12, each pressing tool 75 is moved toward the set portion 72 so that the outer circumferential edge 60d of the airbag 60 is gathered to the upper side of the retainer 52. Then, as illustrated in FIG. 13, each pressing tool 76 is moved toward the set portion 72 so that the remaining part of the outer circumferential edge 60d of the airbag 60 is gathered to the upper side of the retainer 52.

The airbag 60 is folded to the approximately columnar pre-folded body 64 before providing the storage recess portion 65a or 65d by the molding surface 71a on the upper surface of the substrate 71 near the set portion 72, the molding surface 73a near the center of the lower surface of the ceiling wall portion 73, and the molding surfaces 75a and 76a of the pressing tools 75 and 76.

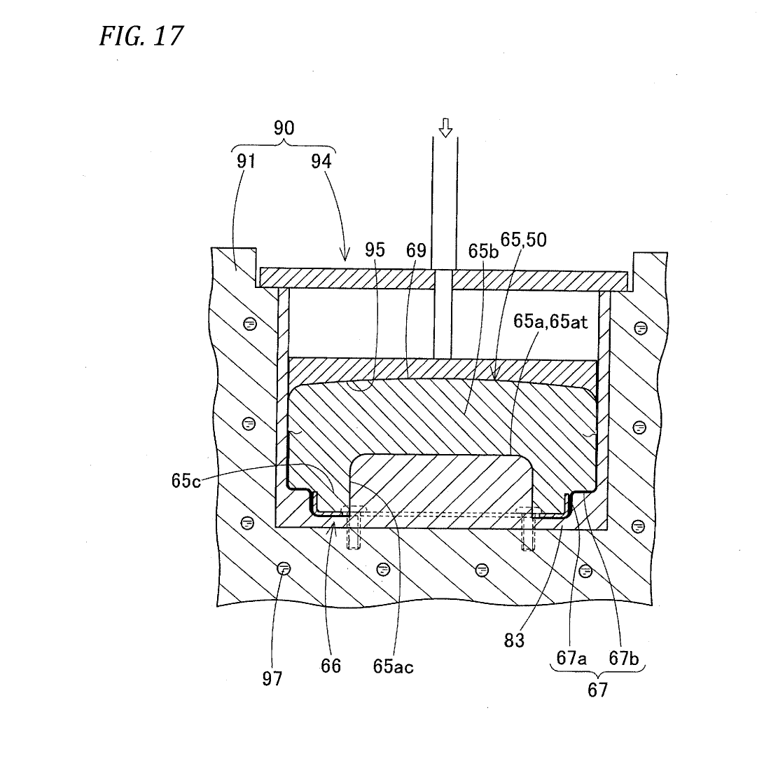

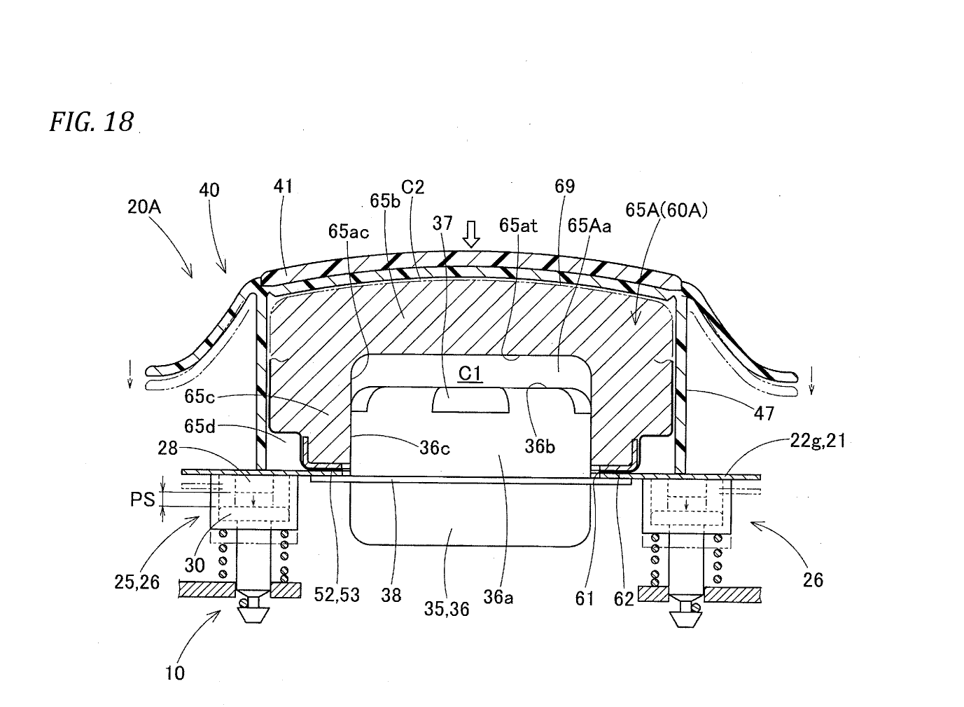

As illustrated in FIGS. 17 and 18, the airbag molding machine 80 heats and compresses the pre-folded body 64, and forms the folded body 65 above the bottom wall portion 53 of the retainer 52. The airbag molding machines 80 or the compression machine (heating compression molding die) is called an airbag heat-compressing machine. In the case of the embodiment, a holding frame portion 83, which is made of metal such as steel excellent in thermal conductivity, is used. The airbag heat-compressing machine (airbag molding machine 80) includes a molding body portion 81 having the set portion 82 storing the holding frame portion 83, and a pressing-side portion 87 which is vertically movable.

The holding frame portion 83 is provided with the cylindrical-shaped side wall portion 83b upward from the outer circumferential edge of an approximately circular bottom wall portion 83a. A storage recess portion 83d into which the pre-folded body 64 assembled with the retainer 52 is fitted is provided in the holding frame portion 83. The assembly hole 84 through which each bolt 55 of the retainer 52 penetrates is provided in the bottom wall portion 83a. A storage convex portion 85 which is capable of forming the storage recess portion 65a and protrudes in an approximately columnar shape is arranged in the center of the bottom wall portion 83a. An approximately annular step convex portion 86 for forming the recess portion 65d as the stepped surface 67 is arranged in the outer circumferential edge of the bottom wall portion 83a, and thus the upper surface of the bottom wall portion 83a serves as a molding surface 83at which shapes the bottom surface 66 of the folding body 65. The inner circumferential surface of the side wall portion 83b serves as the molding surface 83c which forms the outer circumferential surface 68 of the folded body 65.

The assembly hole 82a which is capable of storing each bolt 55 of the retainer 52 is formed in the set portion 82 which stores the holding frame portion 83 of the molding body portion 81.

A pressing surface 88 forming the curved-shaped upper surface 69 of the folded body 65 is arranged on the lower surface of the pressing-side portion 87.

A heater 89 as the heating unit is arranged in the molding body portion 81 and the pressing-side portion 87 such that the temperatures of the pre-folded body 64 set in a state where the temperature rises at the folding process and the holding frame portion 83 can rise to 100° C. or more (about 100 to 150° C.).

The pressing force of the pressing-side portion 87 is within a range of about 80 to 250 N/cm² to have a folded shape which can be stored in a storage space on the airbag holder 21.

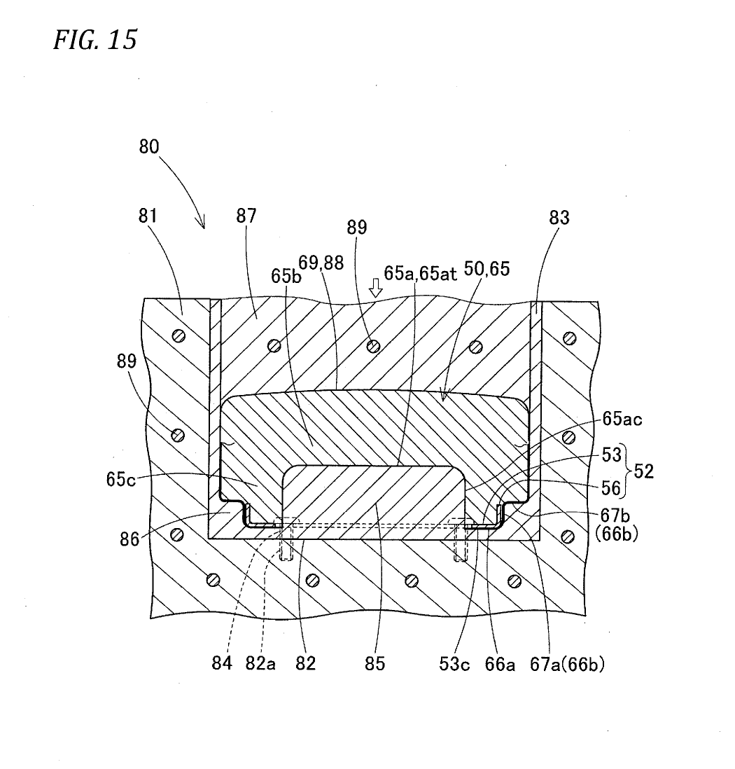

As illustrated in FIG. 14, in the heating compression process using the airbag heat-compressing machine 80, the pre-folded body 64 is disposed on the bottom wall portion 83a such that each bolt 55 protrudes from the assembly hole 84. The pre-folded body 64 is stored in the holding frame portion 83, and the holding frame portion 83 is set to the set portion 82 of the molding body portion 81. As illustrated in FIG. 15, the pressing-side portion 87 is inserted into the set holding frame portion 83, the pre-folded body 64 is compressed and heated, and the compressed and heated state maintains for about 1 to 2 hours.

The temperatures of the molding body portion 81 and the pressing-side portion 87 may be raised by the heater 89 before setting the pre-folded body 64, and may be risen at the time of starting compression, or during compression.

When the predetermined time elapses, the folded body 65 formed in a predetermined folded shape by being assembled with the retainer 52, that is, the completely folded body 50 is formed in the holding frame portion 83.

In the case of the embodiment, in order not to collapse the folded shape for a long period, the folded body 65 is formed by second compression molding that cools down it while maintaining a compressed state using the airbag molding machine (airbag cool-compressing machine or molding die (cooling compression molding die)) 90.

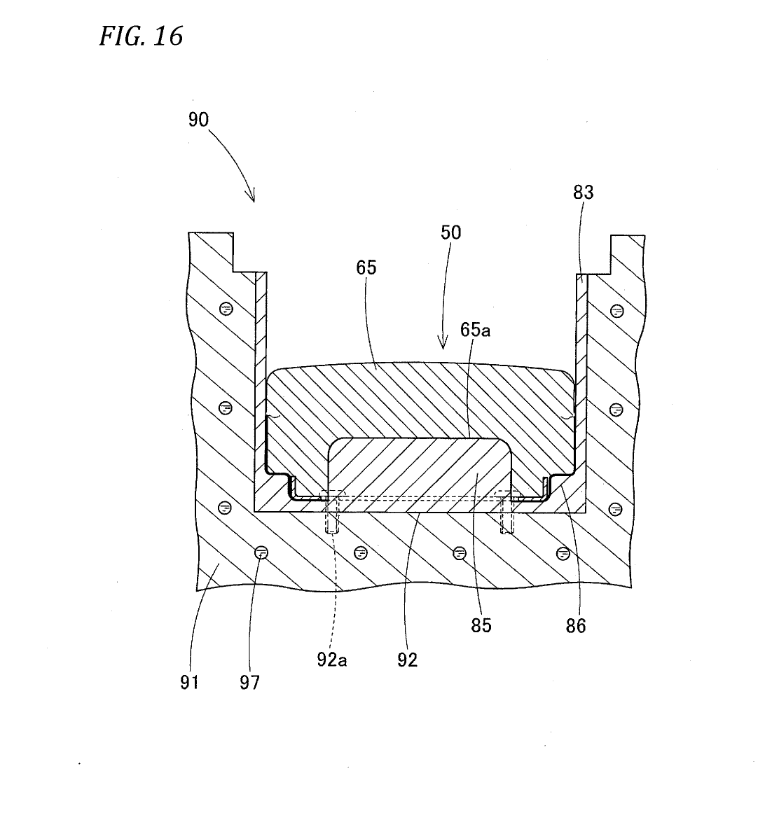

As illustrated in FIGS. 16 and 17, the airbag cool-compressing machine (airbag cool-compressing machine or molding die (cooling compression molding die)) 90 includes the molding body portion 91 having the set portion 92 storing the holding frame portion 83, and the pressing-side portion 94 which is vertically movable. The assembly hole 92a which is capable of storing each bolt 55 of the retainer 52 is formed in the set portion 92 storing the holding frame portion 83 of the molding body portion 91. The pressing surface 95 forming the curved-shaped ceiling surface 69 of the folded body 65 is arranged on the lower surface of the pressing-side portion 94.

A cooling water passage 97 as a cooling unit is arranged in the molding body portion 91 such that the set folded body 65 (completely folded body 50) and the holding frame portion 83 can be cooled to 40° C. or less (about 5 to 40° C.).

The pressing force of the pressing-side portion 94 is within a range of about 30 to 120 N/cm² to have a folded shape which can be stored in a storage space on the airbag holder 21. In the heating compression process before the cooling compression process, the pre-folded body 64 is formed in an almost predetermined folded shape, and the pressing force of the pressing-side portion 94 may be smaller than the pressing force of the pressing-side portion 87 in the heating compression process.

As illustrated in FIG. 16, in the cooling compression process using the airbag cool-compressing machine 90, the holding frame portion 83 having stored the folded body 65 extracted from the airbag heat-compressing machine 80 is set to the set portion 92 of the molding body portion 91. As illustrated in FIG. 17, the pressing-side portion 94 is inserted into the set holding frame portion 83, the folded body 65 is compressed and cooled, and the compressed and cooled state maintains for about 20 to 50 minutes. The molding body portion 91 may be cooled by the cooling water passage 97 before setting the folded body 65, and may be cooled at the time of starting compression, or during compression

When the predetermined time elapses, the folded body 65 formed in a predetermined folded shape by being assembled with the retainer 52, that is, the completely folded body 50 having durability to maintain the folded shape is formed in the holding frame portion 83. As illustrated in FIGS. 6, 7, and 9, the bottom wall cover portion 66a and the bottom wall separated portion 66b provided with the central storage recess portion 65a and the outer edge recess portion 65d are formed in the bottom surface 66 of the folded body 65.

To put the compressing process of the embodiment in other words, the compressing process unit a process to manufacture the folded body 65 through compression molding with a forming mold (airbag molding machines 80 and 90) including a holding frame portion 83 as a portion of the split mold and pressing-side portions 87 and 94 as another portion of the split mold. In the compressing process of the embodiment, without using the common holding frame portion 83, a predetermined forming surface provided with a storage convex portion 85 and a step convex portion 86 may be provided in the molding body portions 81 and 91 of the airbag molding machines 80 and 90, and thus the folded body 65 may be formed from the molding body portions 81 and 91 as a portion of the split mold forming the forming mold (airbag molding machines 80 and 90) and the pressing-side portions 87 and 94 as another portion of the split mold.

When the airbag device 20 mounted with the folded body 65 (the completely folded body 50) is assembled, first, the completely folded body 50 is fitted to the inner circumferential surface 47a of the side wall portion 47 of the airbag cover 40. Each bolt 55 of the completely folded body 50 penetrates through the through hole 22b of the airbag holder 21, and each locking leg portion 49 of the airbag cover 40 is inserted into the locking hole 22e of the airbag holder 21. Each tongue portion 22f is bent outward to be locked to the inner protrusion 49a of the locking leg portion 49, and the outer protrusion 49b of the locking leg portion 49 is locked to the circumferential edge on the outer edge side of the locking hole 22e, whereby the airbag cover 40 is attached to the airbag holder 21. In the airbag holder 21, the switch bodies 26 have already attached. After that, each bolt 55 protruding from the airbag holder 21 penetrates through the through hole 38a of the inflator 35, the nut 58 is tightened to each bolt 55, and the completely folded body 50 (the folded body 65) and the inflator 35 are fixedly attached to the airbag holder 21 having been attached with the airbag cover 40, whereby the airbag device 20 can be assembled.

In mounting the airbag device 20 on the vehicle, the locking head 31 of the assembly pin 29 of each switch body 26 is inserted into the locking hole 11 of the fixing portion 10 of the steering wheel body 1 having been assembled to the steering shaft SS, and the locking head 31 is locked by the locking pin 12, whereby the airbag device 20 can be attached to the steering wheel body 1. Then, the assembly of the steering wheel W is completed, and the steering wheel W can be mounted on the vehicle together with the airbag device 20.

When the airbag device 20 is attached to the steering wheel body 1, a lead wire (not illustrated) of the airbag holder 21 is connected to the positive electrode of the horn switch operating circuit, and the lead wire (not illustrated) for inputting an operating signal is connected to the inflator 35.

After mounting on the vehicle, when the operating signal is input to the inflator 35, the inflator 35 discharges the inflation gas from the gas discharge outlet 37. Accordingly, the folded airbag 60 is inflated by allowing the inflation gas to flow therein, presses and opens the door portion 42 of the ceiling wall portion 41 of the airbag cover 40, protrudes from the opened opening of the door portion 42, and is deployed and inflated to cover the upper surface of the ring portion R from the upper side of the boss portion B (see the two-dot chain lines of FIGS. 1 and 2).

In normal use at the time of non-operation of the inflator 35, when the ceiling wall portion 41 of the airbag cover 40 is pressed down by the operating stroke PS in order to operate the horn switch mechanism 25, the folded body 65 having the shape retention property and contacting with the lower surface 41a of the ceiling wall portion 41 and the switch support portions 22g of the airbag holder 21 is lowered through the side wall portion around the ceiling wall portion 41, and thus the moving-side contact portion 28 of the switch body 26 on the lower surface of the switch support portions 22g of the airbag holder 21 abuts on the fixing-side contact portion 30 in contact manner. Then, the horn switch operating circuit is turned ON such that a predetermined horn is operated.

In a manufacturing method of the folded body 65 of the airbag 60 of this embodiment, the folded body 65 is manufactured in such a manner that the pre-folded body 64 is formed by folding the airbag 60 by the folding process in the state of raising the temperature thereof, and the pre-folded body 64 is heated and compressed and is cooled with maintaining the compressed state by a heating compression process and a cooling compression process. That is, in the folding process, the airbag 60 is folded while the temperature is raised by using the heater 78 of the airbag folding machine 70, and thus the inside of the pre-folded body 64 also is heated. Therefore, the entire pre-folded body 64, which is from the inside of the pre-folded body 64 to the bottom surface 64a, the ceiling surface 64b, and the outer circumferential surface 64c on the external surface, becomes easy to be deformed to a predetermined folded shape of the folded body 65 in a next heating compression process. After that, cooling is performed with the compressed state maintained. Thus, it is possible to obtain the folded body 65 which has durability that can maintain the deformed folded shape for a long time without folding collapse.

Therefore, in the manufacturing method of the airbag folded body 65 of this embodiment, it is possible to manufacture the folded shape to be maintainable for a long time.

The folded body 65 manufactured by the manufacturing method of this embodiment has a shape retention property that can support the ceiling wall portion 41 of the airbag cover 40. For this reason, when the ceiling wall portion 41 of the airbag cover 40 is pressed down in order to operate the horn switch mechanism 25, the ceiling wall portion 41 is supported by the upper surface 69 of the folded body 65 with the shape retention property. In the folded body 65 itself, the side wall portion 65c as a portion around the storage recess portion 65a is supported by the airbag holder 21 through the circumferential edge 62 of the inflow opening 61. Thus, the moving-side contact portion 28 of the switch body 26 on the lower surface of the airbag holder 21 can be allowed to directly approach the fixing-side contact portion 30. As a result, in the airbag device 20 provided with the folded body 65 of this embodiment, a pressing amount of the ceiling wall portion 41 at the time of operating the horn switch mechanism 25 can be the same as the operating stroke PS of the switch body 26, so that the horn switch mechanism 25 can be operated with excellent feeling.

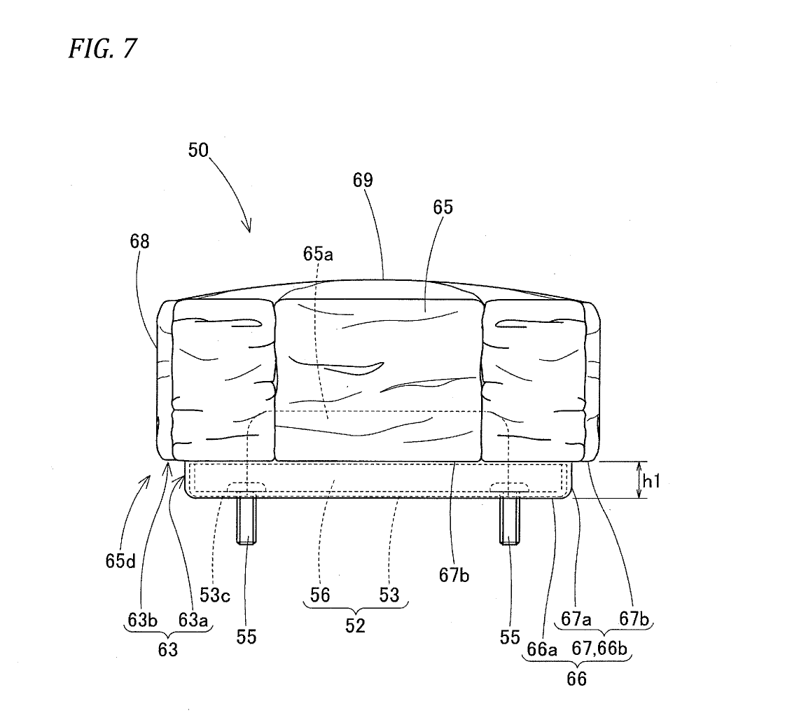

In the folded body 65 manufactured by the manufacturing method of this embodiment, the stepped surface 67 formed by the recess portion 65d is arranged in a portion, which is connected from the bottom wall cover portion 66a, of the bottom wall separated portion 66b of the bottom surface 66 of the folded body 65. The stepped surface 67 includes the vertical surface 67a bent upward from the bottom wall cover portion 66a, and the horizontal surface 67b which is disposed above the bottom wall cover portion 66a from the upper end 67at of the vertical surface 67a, and extends toward the outer circumferential edge 66c of the bottom wall separated portion 66b. That is, when the horizontal surface 67b of the stepped surface 67 is arranged in a position where a jam hardly occurs, a gap H is provided to be separated, by a distance difference (height dimension hl) which is offset upward from the bottom wall cover portion 66a, upward from the base plate portion 22, to which the bolt 55 as the fixing unit is fixed, of the airbag holder 21 as the storage portion (see FIG. 3). Therefore, it can be prevented that the stepped surface 67 of the bottom wall separated portion 66b or the portion 66e adjacent thereto (see FIG. 7) is jammed between the base plate portion 22 of the airbag holder 21 and the bottom wall portion 53 of the retainer 52, and it is possible to assemble the airbag device 20 smoothly. When a portion of the circumferential wall 60a except the attachment portion 62 of the airbag 60 is jammed between the base plate portion 22 of the airbag holder 21 and the bottom wall portion 53 of the retainer 52, the airbag 60 cannot be inflated in a predetermined completely-inflated shape, which is not preferable.

A modification of the folded body 65 may be configured as the folded body 65A of the airbag device 20A illustrated in FIG. 18. In the folded body 65A, the airbag 60A is used which has less volume at the time of being folded than the airbag 60 of this embodiment. Similarly with this embodiment, the folded body 65A is manufactured by the folding process and a compressing process (heating compression process and cool compression process).

In the airbag device 20A, the folded body 65A of the airbag 60A configured to have the shape retention property is formed in such a shape that a gap C1 is provided between the ceiling surface 65at of the storage recess portion 65Aa, which is capable of storing the upper portion 36a of the main body portion 36 of the inflator 35, and the upper portion 36a of the main body portion 36 of the inserted inflator 35. A distance between the upper surface 69 of the folded body 65A and the ceiling wall portion 41 and the airbag cover 40 is not changed, that is, the upper surface 69 facing the ceiling wall portion 41 is not moved down, and a reduced volume of the compact folded shape is adjusted to increase the volume of the storage recess portion 65Aa. For this reason, even when the ceiling wall portion 41 of the airbag cover 40 is pressed down, the ceiling wall portion 41 is depressed only by a slight gap C2 and is supported by the upper surface 69 of the folded body 65A having the shape retention property. Therefore, the ceiling wall portion 41 is not largely bent, and the feeling of the ceiling wall portion 41 of the airbag cover 40 is not degraded. Of course, in the folded body 65A itself, the side wall portion 65c around the storage recess portion 65Aa is supported by the airbag holder 21 through the circumferential edge 62 of the inflow opening 61, and thus the upper surface 69 of the folded body 65A supporting the ceiling wall portion 41 does not descend. As a result, the ceiling wall portion 41 of the airbag cover 40 supported by the upper surface 69 of the folded body 65A does not descend so that the feeling of the ceiling wall portion 41 is not degraded.

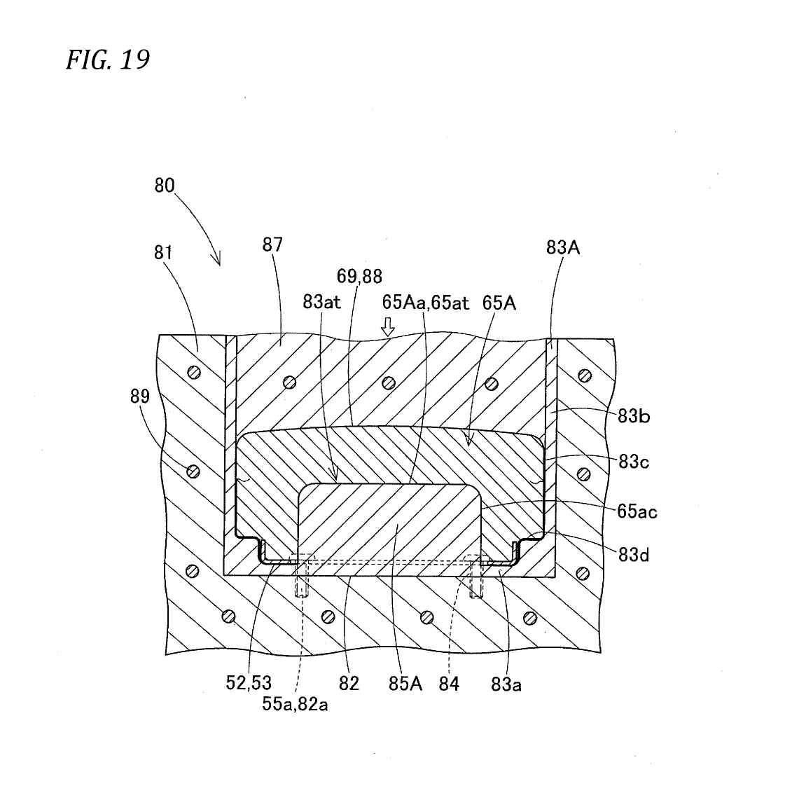

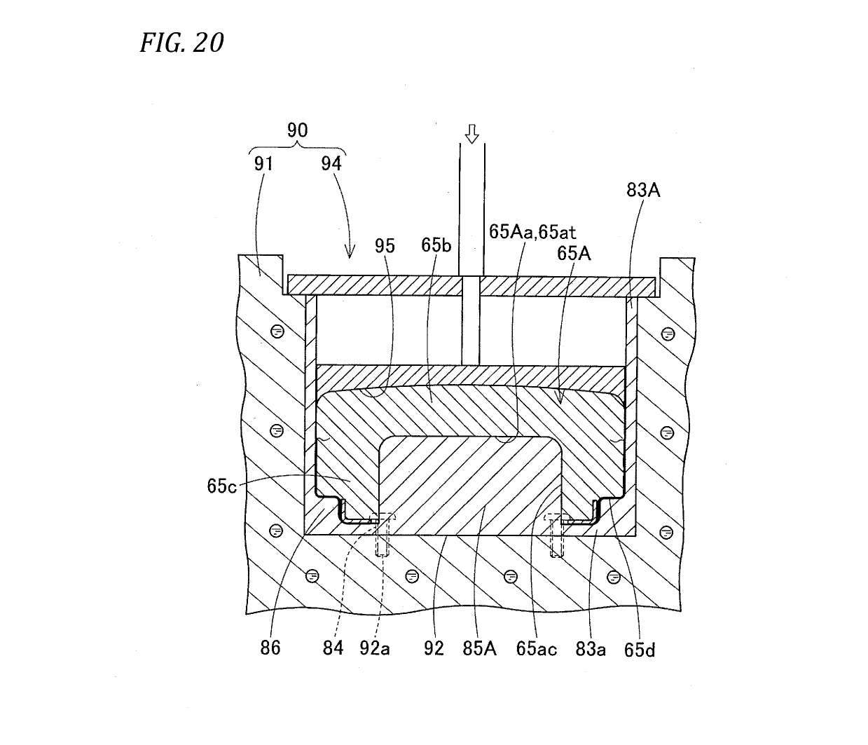

In the case of forming such a folded body 65A, when the folding process using the airbag folding machine 70 or the airbag molding machines 80 and 90 and the compressing process (heating compression process and cool compression process) is used similarly with the airbag 60, it is possible to easily form the folded body 65A from the airbag 60A. Herein, as illustrated in FIGS. 19 and 20, in a holding frame portion 83A used for the compressing process, a storage convex portion 85A used to form the storage recess portion 65Aa corresponds to the storage recess portion 65Aa, and is formed more largely than the storage convex portion 85 of the holding frame portion 83 in FIGS. 15 and 17.

In the example illustrated in the drawings, the shape of the storage recess portion 65Aa can be changed only by changing the storage convex portion 85 to the storage convex portion 85A of the holding frame portion 83A. Thus, it is possible to easily cope with the case of changing the volume of the airbag 60A itself without adjusting the airbag cover 40 or the inflator 35. In the example illustrated in the drawings, the holding frame portions 83 and 83A are replaced in order to change the storage convex portions 85 and 85A. However, when the configuration is provided in which only the storage convex portions 85 and 85A are replaced, the main body of the holding frame portion except the storage convex portions 85 and 85A can be commonly used.

In order to firmly maintain the folded shape of the folded body 65, when the airbag 60 is formed in a predetermined folded shape, the folded body 65 provided with the storage recess portion 65a and the recess portion 65d may be formed by sucking ambient air and by using the compression molding of pressing with a blast as well as the compression molding for clamping the holding frame portion 83 and the pressing-side portions 87 and 94 forming a forming mold.

In the embodiment, at the time of folding the airbag 60, the driver-side panel 60b and the vehicle-side panel 60c are deployed in parallel with each other, and the outer circumferential edge 60d is folded to be gathered toward the attachment portion 62 (the retainer 52). However, when the airbag is folded in a temperature-raised state to be gathered to the upper side of the attachment portion of the airbag, the airbag may be folded from the inflated state to be gathered to the upper side of the attachment portion by extracting a gas, or the airbag may be folded to be gathered to the upper side of the attachment portion by twisting. The folding of the airbag 60 is not limited to the embodiment.

In the embodiment, the folded body 65 is exemplified as an approximately columnar shape. However, the folded body 65 may be formed in a multangular pillar shape such as a rectangular pillar shape.

In the embodiment, the description has been given about the folded body 65 which is used in the airbag device 20 mounted on the steering wheel W. However, as long as the airbag is folded to be gathered to the upper side of the attachment portion, the invention may be applied to a completely folded body used in a passenger seat airbag device and the like.

What is claimed is:

1. A method of manufacturing a folded body of an airbag, which is inflated by allowing an inflation gas, including: an inflow opening through which the inflation gas is allowed to flow; and an attachment portion of the circumferential edge of the inflow opening, the airbag being formed as a folded body having a folded shape of being gathered to an upper side of the attachment portion, the attachment portion being attached to an attachment seat of a storage portion, the method comprising:
folding the airbag, in the state of raising a temperature of the airbag, to form a pre-folded body;
heating and compressing the pre-folded body, and
cooling and compressing the pre-folded body, which is heated and compressed, to form the folded body.
